(19) United States
(12) Patent Application Publication
(10) Pub. No.: US 2007/0106653 A1
(43) Pub. Date: May 10, 2007

(54) Search engine

(76) Inventor: Yu Sun, Salt Lake City, UT (US)

Correspondence Address: PETER K. TRZYNA, ESQ., P O BOX 7131, CHICAGO, IL, 60680, US

(21) Appl. No.: 11/581,213

(22) Filed: Oct. 12, 2006

Related U.S. Application Data
(60) Provisional application No. 60/725,955, filed on Oct. 12, 2005.

(51) Int. Cl. G06F 17/30

(52) U.S. Cl. 707/4

(57) ABSTRACT

A method implemented with a machine, the machine, and the method for using the machine, and products produced thereby, the method including a computer system arranged to allow a user to input search phrases and/or words in one language and the system translates the phrases and/or words into one or several user-specified languages and then presents search results from a multi-language search to the user.

### I. PRIORITY STATEMENT

This patent application is a continuation in part of, claiming priority and incorporating by reference from, U.S. patent application Ser. No. 60/725,955 filed Oct. 12, 2005, by the same inventor, titled “Internet Services,” and U.S. Patent Application filed contemporaneously herewith on Oct. 12, 2006, by the same inventor and having Express Mail Label No. EV 623993765 US and titled “Content That Is Searchable But Inhibited.”

### TECHNICAL FIELD

The technical field is computers and data processing systems. Depending on the implementation, there is apparatus, a method for use and method for making, and corresponding products produced thereby, as well as data structures, computer-readable media tangibly embodying program instructions, manufactures, and necessary intermediates of the foregoing, each pertaining to digital aspects of network communication, such as over the Internet, e.g., by way of, or inclusive of, such as a search engine.

### III. BRIEF DESCRIPTION OF THE DRAWINGS

FIG. 1 illustrates an embodiment.

FIG. 2 illustrates an embodiment.

FIG. 3 illustrates an embodiment.

FIG. 4 illustrates an embodiment.

FIG. 5 illustrates an embodiment.

FIG. 6 illustrates an embodiment.

FIG. 7 illustrates an embodiment.

### IV. MODES

The accompanying drawings are intended to illustrate and exemplify in a teaching manner. Therefore, embodiments used to carry out the teaching should not be viewed as limiting, but rather, should be viewed as instructively building to an overall teaching.

As used herein, the term “computer” or “computer system” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow can be implemented in discrete circuits. Computer-readable media, as used herein can comprise at least one of a RAM, a ROM, a disk, an ASIC, and a PROM. Industrial applicability is clear from the description, and is also stated below.

By way of the following prophetic teaching, there is provided computer (and support thereof), as in a data processing system, for implementations pertaining to embodiments herein, as well as related or necessary computer support such as for allowing or facilitating a multi-language search engine that provides functions to translate search words and phrases and then does searching with the translated words and phrases.

By way of the following prophetic teaching, there is provided computer (and support thereof), as in a data processing system, for implementations pertaining to embodiments herein, as well as related or necessary computer support.

Consider the following situation. People who know one language but not an other, e.g., English, well can have trouble to choosing proper words and/or phrases in the other language. There are problems with trying to use a dictionary every time they want to search some English contents, so perhaps the people guess. Sometimes they guess wrong, and in any case, they do not find the information being sought. Some embodiments herein allow people to search with their own language and let the search engine translate to proper words and/or phrases and then do the search. The people can also, in some embodiments, use translation tools to read the search results.

For example, imagine a Chinese user wants to know what is new in the field of “dome lighting” in United States. He or she can read some English but can not determine the proper wording for “dome lighting”, even he/she knows the term in Chinese. He/she has to take time to find the right word/phrase from dictionary usage before he/she can search or he/she can guess and perhaps miss information that is desired.

A multi-language search engine can let people input the search phrase in their preferred language. The search engine can automatically translate the phrases to the searching language(s) and then do the search. If there are multiple translations, e.g., for a phrase, each translated phrase can be listed as a category and the search results can be shown in each translated phrase category.

The translation can be done on server side or on user side, depending on the embodiment that may be preferred for any particular application. One embodiment is to do a word-to-word dictionary translation. Words and Phrases, quotations, etc. are other approaches to constructing phrases for searching.

Yet another embodiment can involve doing a search in selectable or multiple languages to maximize identification of search results.

An embodiment instructive for teaching is to have an Internet service that provides a multi-language search engine that functions to translate search words and/or phrases; and then does searching with the translated words and phrases. A multi-language search engine can facilitate users inputting the search word and/or phrase in their prefer language and choose a different searching language, e.g., one or more searching languages. The search engine translates the phrases to the searching language(s), conducts the search(es), and presents the results. If there are multiple translations, each translation can be utilized for categorizing the results.

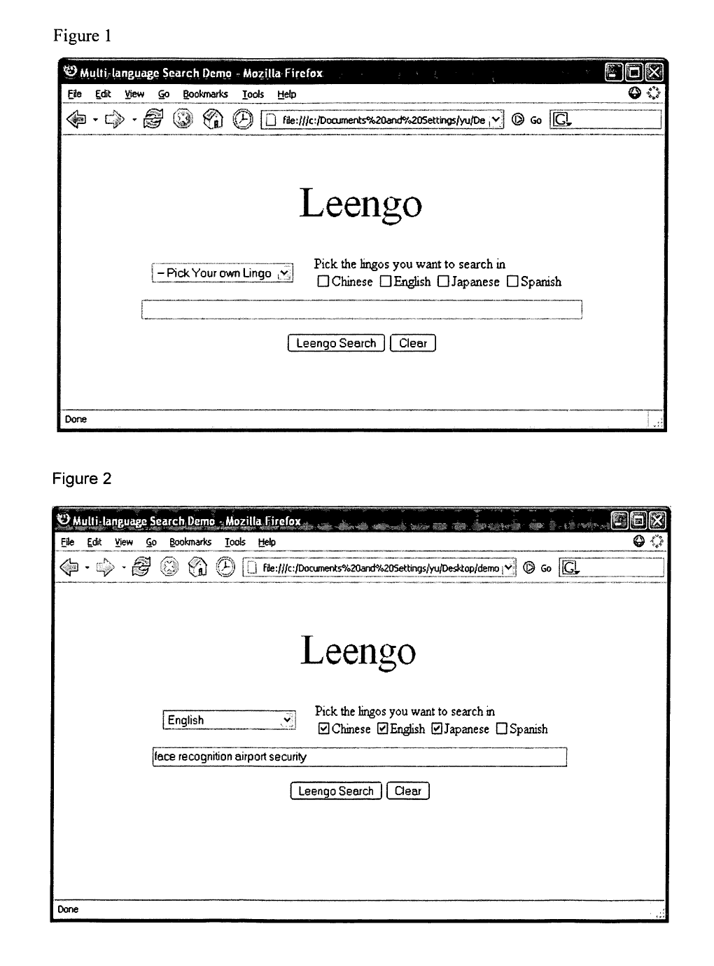

Referring to FIG. 1, one way of carrying out the ideas herein is to have 3 parts, a user interface, a translator, and a search engine. The translator can be on the user or client side, or on the search engine side. The user interface can be structured to solicit user input or a selection to specify the search language, and if one wishes, the user's input language. Input can, depending on the embodiment preferred, comprise search words and/or phrases. The interface can be a HTML web page displayed with a web browser or a program that exists with or without a web browser.

So for example, a user can chooses “English” for user's language, say, by choosing a box, and then can choose “Chinese”, “English”, and “Japanese” as the languages for conducting the searches. The user can also input whatever words and/or phrases for the search in English. After clicking a search button or otherwise submitting or initiating the search request, and the search words, user language, and the search languages can be sent to a server (e.g., in a server side embodiment). A program, e.g., executing on the server, receives the search request and parses the request to get the search words and/or phrases, user language, and the search languages.

In one illustrative embodiment, a program calls a translator program to translate all the words and/or phrases to selected language(s). All or parts of the possible translations returned from the translation program are saved in corresponding lists. (Syntax recognition can be used for selecting translation wording in phrases in server or client embodiments. There are many state of art techniques to translate phrases and sentationce) Each list can have several translations, with each translation comprising is a set of one or more phrases and/or words. Each list is associated with a language. The lists can be named as words_english, words_chinese, and etc. Each translation is sent to the search engine to search for relative web pages. The search results are related to the translation. The translations can be categorized by the language(s), and all the search results categorized with translation and language are sent back to user (i.e., user device). The translation to the first selected language can be displayed. The search results of the first translation in the first selected search language can be displayed. The other translations and the other languages can be displayed, e.g., as options. If the user selects another translation or another language, the relative search results can then be displayed similarly.

In another illustrative embodiment, a program calls a translator program to translate the words and/or phrases to one of the selected search languages. The language is called the current search language. The current search language can be the first listed in the checking list or as selected by user. All or parts of the possible translations returned from the translation program are saved in a list. The list has one or more translations, i.e., a current translation list. Each translation is a set of one or more phrases and/or words. A translation is sent to the search engine to search for web pages to produce current search results. The current translation can be the first one in the list or as selected by the user, i.e., at the user interface. The current search results of the current translation, the translation list, and the language are sent back to user. The languages and the translation list are displayed at the end user device. The current search language can be displayed in a manner different from the other languages. For example, suppose the current search language is Chinese. The display of “Chinese” can be displayed in a different format, color, underline, etc. to distinguish Chinese from the other listed languages. If the user selects another translation, a new search on the selected translation list will be sent to the search engine directly and a search result will be returned and displayed. Again, the current translation will be shown differently from any other translation. If the user selects another language, the search phrases and/or word in user language are sent to the translator program to be translated to this next language. Now this next language becomes the current search language. As before, all or parts of the possible translations returned from the translator program are saved in a list. The list can thus have several translations. Each translation is a set of one or more phrases and/or words. A translation is sent to search engine to search for web pages. The translation, i.e., the current translation, can be the first one in the list or as selected by the user by user interface. The search results of the translation with the translation, the translation list, and the language are sent back to user. The languages and the translation list are displayed. The current search language is preferably displayed differently from the other languages. The current translation is preferably displayed differently from the other translations, similar to the above-given embodiment.

Embodiments herein can also provide a web page translator capable of translating the search result(s) to the user language for being displayed, e.g., along with the untranslated search result.

The following demonstrates the server side implementation. Imagine, for example, that a user wants to search “face recognition airport security” and wants to search in English, Chinese, and Japanese. The user's native language is English and he knows a little bit of Chinese and Japanese. The user does not know the translations of the foreign-language searching words. The user does not want to look into a dictionary from concern that he/she might choose the wrong translations. So, the user goes to a multi-language search web site as described above. The front page of the web site can be as shown in FIG. 1.

Then the user chooses “English” in a “choosebox” and selects “Chinese”, “English”, and “Japanese” as the languages desired for the searching. The user then types in “face recognition airport security” in the text box as shown as an example in FIG. 2.

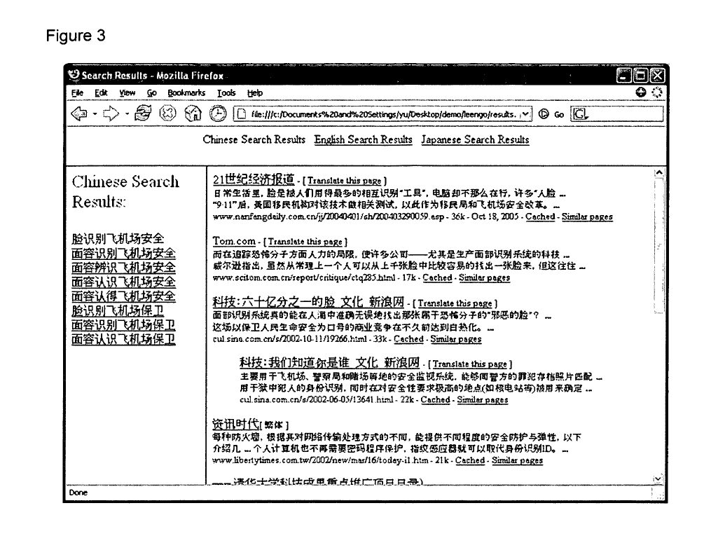

Then the user presses a button, such as “Leengo Search”. The web site then translates the searching words into Chinese and Japanese. For each language, there can be several translations for each word, the combination of all the translations of each words in this language can used for searching in this language, or otherwise, e.g., via syntax recognition in a phrase. After searching different combinations, as may be necessitated, and in selected languages, the search results are sent back to the user and displayed as exemplified in FIG. 3.

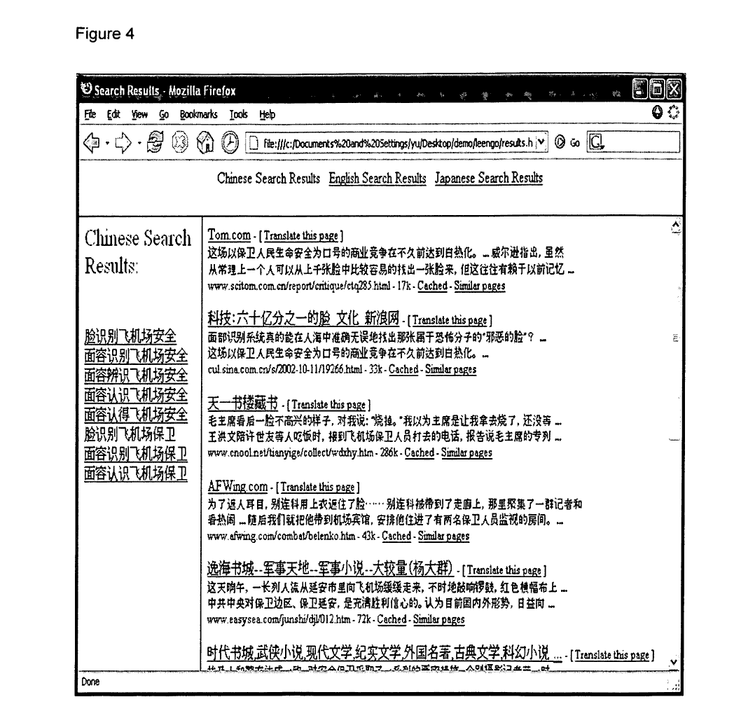

FIG. 3 shows the search results. The top frame has the languages listed. The user can choose which language that the search engine will use for searching. Default in all cases can be such as the language the user has chosen. The display can, depending on the embodiment, be set to the user's language, or one or more others. So, for this particular embodiment, the language is Chinese. A left frame shows all combinations of the translations of all the words. A default showing in the right frame is the search results of the first combinations shown in left frame. The user can choose another language in the top frame and/or choose another combination in the left frame and the searching results will be refreshed in the right frame. FIG. 4 shows the search results when user clicks another translation combination.

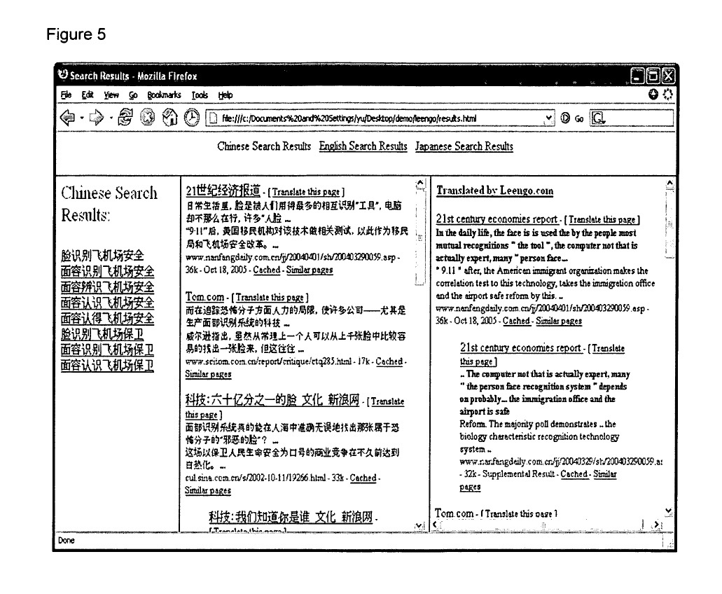

The user can also choose to show the searching results with the content translation to his/her native language. For this example, the user selected English as his/her native language. As demonstrated in FIG. 5, the searching results of Chinese web pages are displayed in Chinese and in English with content translation.

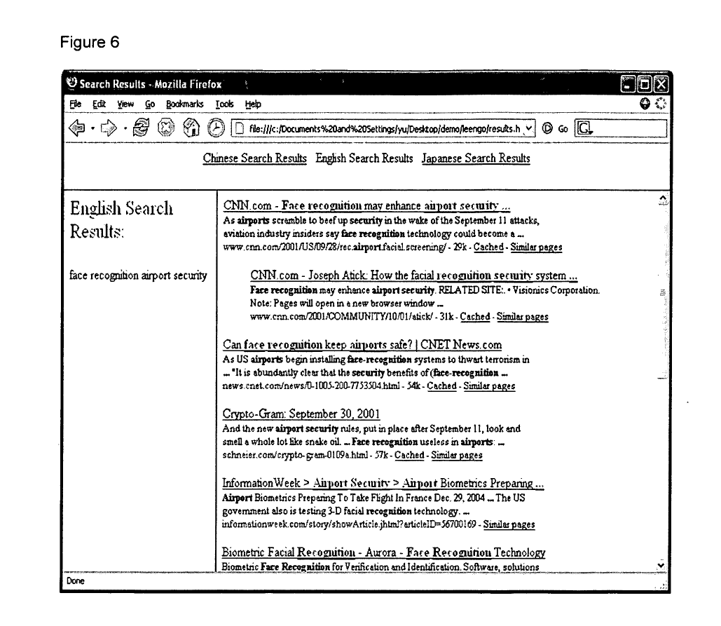

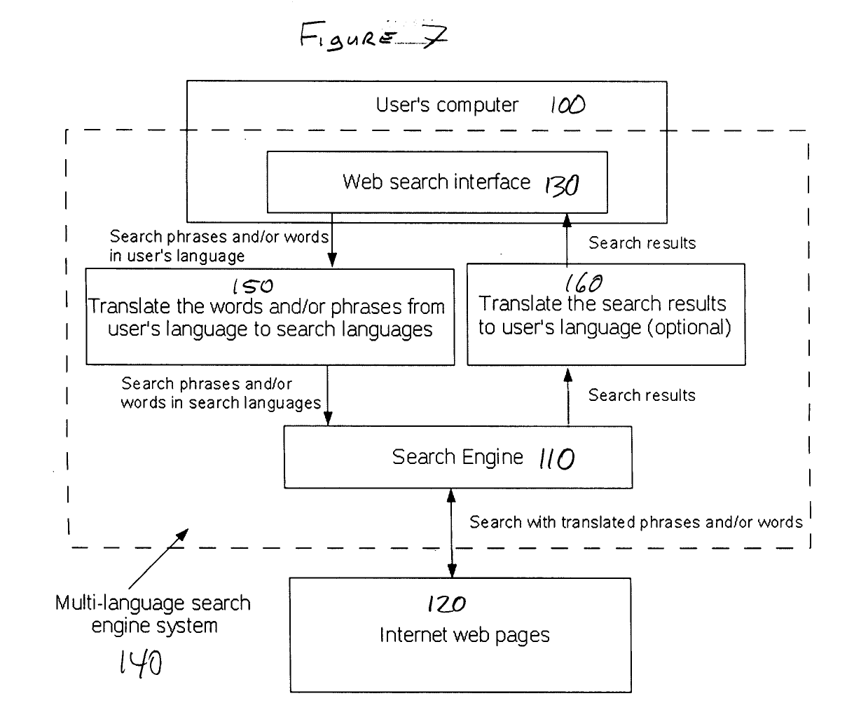

If the user wants to look the search results in the native language, English, the user clicks on “English” in the top frame. The search results shows in FIG. 6.

In such an embodiment, the system can function as the follows. After the user selects all the user's languages and the languages desired for searching, the user presses the “Leengo Search” button. The search requirements are sent to the web site. The requirements are handled by a program executing at the web site server. The program translates all the words to all the languages the user selected. There can be several possible translations for each word in each language. All possible combinations are made with all the possible translations of all the words in each language, noting another embodiment possibility of syntax recognition for words in phrases. Searches are then made with all the combinations or viable combinations in view of, say, syntax. Search results are indexed with the search combinations and languages. Then the languages, translation combinations and search results are sent back to the user. The results can be displayed as illustrated in the above-discussed embodiment or some other way, as may be preferred in one embodiment or another. The search can also be carried out with one combination and one language at a time, and then the results of that combination can be sent back to the user right away. Then the user can choose another combination or language and another search with the new combination will be carried out and results will be sent back to the user and so on. In yet another embodiment, the search can be carried out in a stepwise manner, with results being fed back to the user device step by step through any embodiment herein, and organized step by step, too. The search results can be translated to the user's native language and displayed.

Illustrative of the foregoing can be the following coding:

The Interface html Code:

<html>
<header>
<title>Multi-language Search Demo</title>
</header>
<body>
<br>
<br>
<center><font size=8>Leengo</font>
<br>
<br>
<form name=“leego” action=“search.cgi”>
<table cellspacing=“10” align=“center | center” border=“0”>
<tr>
<td>
<select name=“InputLingo”>
<option>-- Pick Your own Lingo
<option>Chinese
<option>English
<option>Japanese
<option>Spanish
</select>
<td>
<td>
<!--
<select name=“searchLingo”>
<option>-- Pick the Lingo you want to search in
<option>Chinese
<option>English
<option>Japanese
<option>Spanish
</select>
-->
Pick the lingos you want to search in<br>
<INPUT TYPE=checkbox NAME=“l1” VALUE=“Y”>Chinese
<INPUT TYPE=checkbox NAME=“l2” VALUE=“Y”>English
<INPUT TYPE=checkbox NAME=“l3” VALUE=“Y”>Japanese
<INPUT TYPE=checkbox NAME=“l4” VALUE=“Y”>Spanish
<td>
</tr>
</table>
<input name=“input” type=“text” size=“80” maxlength=“100”>
<br>
<input type=“submit” value=“Leengo Search”>
<input type=“reset” value=“Clear”>
</form>
</center>
</body></html>

FIG. 7 is to teach by way of a representative configuration. There can be one or more end user stations or computers 100, each for a visitor or end user (not shown). At least one of the computers 100 can be comprised of a digital computer with a processor (such as an Intel Pentium or Centrino processor), a memory, an input device (such as a keyboard, mouse, speech recognizer, disk or CD drive, computer-to-computer communication device, etc.), and an output device (such as a monitor, printer, disk or CD drive, or a computer-to-computer communication device such as a modem). The memory can include an operating system such as Windows or Linux to run the computer 100, for example, enable application(s) software.

A computer 100 can use its computer-to-computer communication device to communicate via wide area network (WAN), such as the Internet, where a computer 100 can interact with a search engine 110. The search engine 110 can facilitate a search of content on the WAN, such as pages 120 (or content stored therefrom).

Computer 100 can have a user interface 130 utilizing a multi-language search engine 140, illustrated such that engine 140 may be local to computer 100 or may not, and search engine 110 may be a component of engine 140 or may not, i.e., the engine 140 interacts with an independent search engine, depending upon the embodiment preferred in one application or another.

In any such embodiment, search phrases and/or words in the user's language are conveyed from the interface 130 to translator 150 to translate the words and/or phrases from the user's language to the search language(s). The search phrases and/or words in the search languages are communicated to the search engine 110, which searches the web pages 120 and reports search results to (optionally, depending on the embodiment) translator 160 to translate the search results to the user's language. The translated search results are then conveyed from translator 160 to the interface 130 at the user's computer 100.

Imagine another embodiment somewhat similar to FIG. 7, but differently configured to extend the user's computer 100 box not only includes the “web search interface” but also includes the “Translate the words and/or phrases from user's language to search languages” and “Translate the user search results to user's language (optional)” boxes. This configuration would be more in keeping with a client-side translator embodiment.

Note that embodiments herein, if so preferred, can be utilized in conjunction or combination with the system of encrypted web pages as per the patent applications mentioned above as being incorporated by reference herein.

In another embodiment, the multi-language searching engine can be used for any websites that provide a search engine, as Amazon. However, to attract non-English speaking people, such websites can provide two versions of each webpage, such as in English and another such as in Spanish. This facilitates users conducting their searchs in English or Spanish. However, an embodiment herein can undermine the need to have 2 or more versions of each webpage because translation can be done on the fly with the search engine. With such a technique, a non-English speaking end user can search in English with non-English input. The multi-language search capability is particularly on point when applied to enable a search leading to a purchase over the Internet.

An other way of instructing and teaching embodiments herein is to consider a system and process whereby a user is allowed to input search phrases and/or words in one language and the system translates the phrases and/or words into one or more user-specified languages prior to conducting a search with the translated phrases and/or words to produce search results returned to the user.

There can be an interface, displayed on a screen of a user device, to facilitate the user's selection of a search language or languages. The user language can, if desired, be set by default or be selectable, depending on the preferred application of teachings provided herein. A default setting can be triggered by the language of the operating system, web browser, or interface software. The interface can display such as the search language(s) and any options therefore, translated search phrases and/or words, and the search results.

A program or script can take the input phases and/or words and translate them to the desired languages. For each language, if there are many possible translations, and all or part of the possible translations can be used in the searching to produce search results.

A program or script can categorize the search results in association with the languages.

The interface can, if preferred for a particular embodiment, list the search language(s) in association with the search result(s). In another embodiment, the interface can allows the user to select which search language to use for displaying the search results.

A program or script can categorize the search results with the possible translations of each language, in an embodiment, if so desired. The search results can be displayed to user with the search phrase and/words, if so desired for a particular embodiment.

The interface can list the possible translations of the search phrases and/words, and/or allows the user to select which translation of the search phrases and/or words to search for—again depending on how one should wish to implement the teachings herein. Similarly, the interface can that list the possible translations of the search phrases and/words. Also similarly, the interface can be adapted to allow the user to select to display the search results based on which translation of the search phrases and/or words is preferred, e.g., by allowing the user to select or switch to a particular language. The interface can also be adapted to allow the user to select or switch to search results based on a search language.

Accordingly, some embodiments can be viewed as including, depending on the implementation, apparatus, a method for use and method for making, and corresponding products produced thereby, as well as data structures, computer-readable media tangibly embodying program instructions, manufactures, and necessary intermediates of the foregoing. Representatively, consider an embodiment characterized as a method for using an apparatus.

More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Although the disclosure herein has been described with reference to specific embodiments, the disclosures are intended to be illustrative and are not intended to be limiting. Various modifications and applications may occur to those skilled in the art without departing from the true spirit and scope of the invention as defined in claims.

Thus, although only a few exemplary embodiments have been described in detail above, those skilled in the art can readily appreciate that many modifications are possible in the exemplary embodiments without materially departing from the novel teachings and advantages herein. Accordingly, all such modifications are intended to be included within the scope defined by claims. As used herein, means-plus-function is intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

I claim:

1. A computer system providing multiple language searching of web pages, the system including:
a search engine facilitating searching of web pages in more than one language;
a user device adapted to communicate a search request to the search engine; and
means for generating a user interface to enable the search.

2. A computer system to conduct a search over the Internet, the
a search engine operating on at least one computing device, the search engine arranged to receive, from a user device, information requesting a search of content on the Internet, to conduct the search in more than one language, and to communicate the results to the user device.

3. A computer-readable media tangibly embodying a program of instructions executable by a computer to perform the operations of:
generating a user interface at an end user device, the user interface adapted to solicit input to produce a request for a search engine to conduct a search of the Internet in more than one language and to trigger communication of results from the search to the device.

4. The media of claim 3, wherein the media comprises at least one of a RAM, a ROM, a disk, an ASIC, and a PROM.

5. A method of conducting a search of web sites, the method including:
receiving a request, at a search engine operating on at least one computing device, to conduct a search in more than one language of web sites; and
providing results of the search to an end user device corresponding to the request.

6. System for searching in multiple languages, the system including:
an end user device controlled to display a user interface soliciting input to produce a request to conduct a search in more than one language; and
a search engine, operating on at least one computing device, to receive the search request and to conduct the search over the Internet to produce search results; wherein the end user device is adapted to display the search results conveyed by the search engine.

7. The system of claim 6, further including a translator, at the user device, to translate the input to produce a translation that is comprised in the search request.

8. The system of claim 6, further including a translator, at said at least one computing device the translator produce a translation that is comprised in the search request
